(19) United States
(12) Patent Application Publication
(10) Pub. No.: US 2001/0042095 A1
(43) Pub. Date: Nov. 15, 2001

(54) System and method for providing chat service for mobile terminal

(76) Inventors: Kwang-Muk Kim, Kyungki-do (KR); Sang-Il Lee, Kangwon-do (KR); Dong-Jin Shin, Seoul (KR); Kwang-Suk Joo, Seoul (KR)

Correspondence Address: Douglas W. Sprinkle, Gifford, Krass, Groh, Sprinkle, Anderson & Citkowski, P.C., 280 North Old Woodward Avenue, Suite 400, Birmingham, MI, 48009, US

(21) Appl. No.: 09/772,638

(22) Filed: Jan. 30, 2001

(30) Foreign Application Priority Data
May 15, 2000 (KR) 2000-25828

(51) Int. Cl. G06F 15/16

(52) U.S. Cl. 709/204

(57) ABSTRACT

Disclosed is a system for providing a chat service, which enables a user of a mobile terminal to search for another user meeting some specified requisites for a chat partner and to virtually talk with him/her, the system including: a mobile communication system being in radio communication with the mobile terminal; a chat server connected to a network for providing the chat service; and a radio operator gateway for switching different data and protocols between the mobile communication system and the network. The chat server includes personal information and requisite information of at least one member. Upon a request of the user of the mobile terminal for the chat service, the system searches for a member meeting the requisites of the user for a chat partner based on the personal information of the individual members, compares the requisite information of the user with that of the searched member to select a chat partner and enables the user to virtually talk with the selected chat partner. According to the present invention, the user of the mobile terminal searches for a chat partner meeting some specified requisites to access a chat service on a one-to-one basis in real time, thus enhancing the chat success rate, and uses the navel matching information based on the navel information as well as character information to select a chat partner with enhanced reliability to the chat service.

### BACKGROUND OF THE INVENTION

(a) Field of the Invention

The present invention relates to a system and method for providing a chat service for mobile terminals. More specifically, the present invention relates to a system and method for providing a chat service for mobile terminals, by which the user of the mobile terminal can search for another user meeting some specified requisites for a chat partner and virtually talk with him/her.

(b) Description of the Related Art

Recently, rapid distribution of the world wide web (WW) network commonly known as Internet and diversity of interface types have broaden the scale of computer networks. As a result, the users of the mobile communication system are enabled to connect the Internet network over the mobile communication network and to use the Internet service with mobile terminals.

On the other hand, bi-directional interactive communications using networks, e.g., common communication network, cable television (CATV) network and Internet have been widely spread. Bi-directional interactive communication, so-called on-line “chat”, adopts the way that a number of users connecting the network by way of the communication program provided by a network server virtually talk with one another in the chat session.

As the Internet connection and bidirectional interactive communication via mobile terminals have been widely spread, there is a demand of providing a chat service via mobile terminals.

Complying with this, some mobile communication service providers are providing chat services via mobile terminals. In the chat services provided by those providers, however, it takes too much time and cost for the user of the chat services to find an adequate chat partner, because he/she has no knowledge of the chat partner and cannot find if the chat partner meets some specified requisites for an ideal partner, until he/she actually has a conversation with the partner in the chat room for a period of time.

### SUMMARY OF THE INVENTION

It is therefore an object of the present invention to solve the problem with the prior art and to provide a system and method for providing a chat service, by which a user of the mobile terminal can search for another user meeting some specified requisites for a chat partner and virtually talk with him/her on the one-to-one basis in real time.

In one aspect of the present invention, there is provided a system for providing a chat service, which enables a user of a mobile terminal to search for another user meeting some specified requisites for a chat partner and to virtually talk with him/her, the system including: a mobile communication system being in radio communication with the mobile terminal; a chat server connected to a network for providing the chat service; and a radio operator gateway for switching different data and protocols between the mobile communication system and the network. The chat server includes personal information and requisite information of at least one member. Upon a request of the user of the mobile terminal for the chat service, the system searches for a member meeting the requisites of the user for a chat partner based on the personal information of the individual members, compares the requisite information of the user with that of the searched member to select a chat partner and enables the user to virtually talk with the selected chat partner.

The mobile communication system includes at least one mobile communication service system. The at least one mobile communication service system is connected to the network via the radio operator gateway.

The at least one mobile communication service system belongs to at least two mobile communication service providers.

In another aspect of the invention, there is provided a method for providing a chat service, which enables a user of a mobile terminal to search for another user meeting some specified requisites for a chat partner and to virtually talk with him/her, the method including the steps of: causing the chat-requesting user to enter requisites for a chat partner; searching for a member meeting the requisites; comparing the requisite information of the searched member with that of the user to search for the chat partner; calling the searched chat partner; and enabling the chat service between the called chat partner and the chat-requesting user.

The requisite information of the member includes navel information and character information, or either of them. In particular, the navel information is well known to the skilled in the art and broadly used to refer horoscope between opposite sexes or to obtain love index. Traditional naval information is disclosed in “Man and Woman that cannot be understood” by Lee, Sang-II (Shinsung Media, 1999), “Best Contact and Best Love” by Lee, Sang-II (Infinite, 2000), “New Mental Medicine, Second Edition” by Min, Sung-Gil (II Jo Gak, 1996), “Mental Medical Treatment Theory” by Lee, Young-Sil (Shin-Han, 1996), “Dream Analysis” by Freud (Sun Young Sa, 1999), etc, and referred to in this specification.

The naval information includes blood type, favorite diagram, kaivawibo pattern, favorite food, etc. It is possible to determine if the searched chat partner is a good match of the chat requester, based on the navel matching of the navel information between the chat partner and the chat requester.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram showing a system for providing a chat service for mobile terminals in accordance with an embodiment of the present invention;

FIG. 2 is a flow chart showing a method for providing a chat service for mobile terminals in accordance with another embodiment of the present invention;

FIGS. 3a to 3e are diagrams showing the examples of navel matching by navel information; and

FIG. 3f is a diagram showing the results of the navel matching according to FIGS. 3a to 3e.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

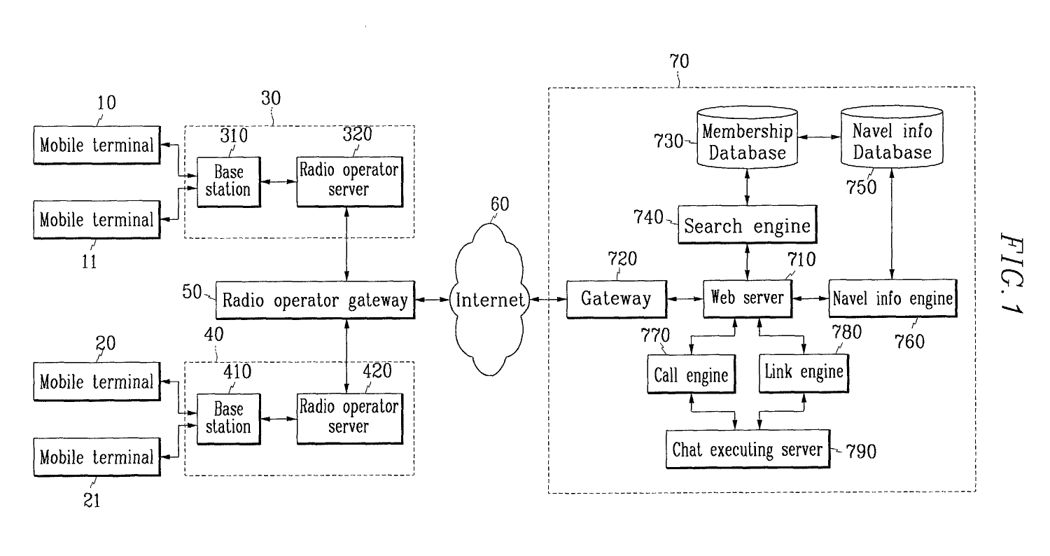

FIG. 1 is a block diagram of a system for providing a chat service for mobile terminals in accordance with an embodiment of the present invention.

As shown in FIG. 1, mobile terminals 10, 11, 20 and 21 independently get in radio communication with mobile communication systems 30 and 40. The mobile communication systems 30 and 40 belong to the same mobile communication service provider or different mobile communication service providers. In this embodiment, the description will be given on the assumption that the mobile communication systems 30 and 40 belong to different mobile communication service providers.

The mobile communication systems 30 and 40 includes, respectively, base stations 310 and 410 in radio communication with the mobile terminals 10, 11, 20 and 21, and radio operator servers 320 and 420 processing a call received from the mobile terminals 10, 11, 20 and 21 via the base stations 310 and 410.

The radio operator servers 320 and 420 of the mobile communication systems 30 and 40 are connected to an Internet server 60 via a radio operator gateway 50.

To the Internet server 60 is connected to a chat server 70 providing a chat service for the mobile terminals 10, 11, 20 and 21.

The chat server 70 displays a home page and web pages relating to the chat service, and includes a web server 710 controlling the whole chat-related operation.

The web server 710 is connected to the Internet server 60 via the gateway 720.

The chat server 70 also includes a membership database 730, a search engine 740, a navel information database 750, a navel information engine 760, a call engine 770, a link engine 780, and a chat executing server 790.

The membership database 730 stores the personal information of the members subscribed to the chat service provided by the present invention. Here, the members may include not only the users of the mobile terminals 10, 11, 20 and 21 but also those of computer systems, particularly, personal computers directly connected to the Internet server 60.

The search engine 740 is connected to the web server 710 to search for the personal information of a member stored in the membership database 730. The personal information includes the member's ID, address, age, relationship, height, character, and the like.

The navel information database 750 stores the navel information of the members.

The navel information includes blood type, favorite diagram, kaivawibo pattern, favorite food, and music genre to listen to with the chat partner.

The call engine 770 is connected to the web server 710 to call the last member searched out as a chat party meeting the specified requisites.

The link engine 780 is connected to the web server 710 to connect the chat-requesting user to the called member who is in connection with the web server 710.

The chat executing server 790 controls the chat service so that the chat-requesting user can have a chat with the called member.

As described above, the users of the mobile terminals are enabled to use the Internet service via the radio operator gateway 50 connecting the mobile communication systems 30 and 40 to the Internet server 60, and the chat server 70 is connected to the Internet server 60, which enables a chat service for the users of the mobile terminals 10, 11, 20 and 21.

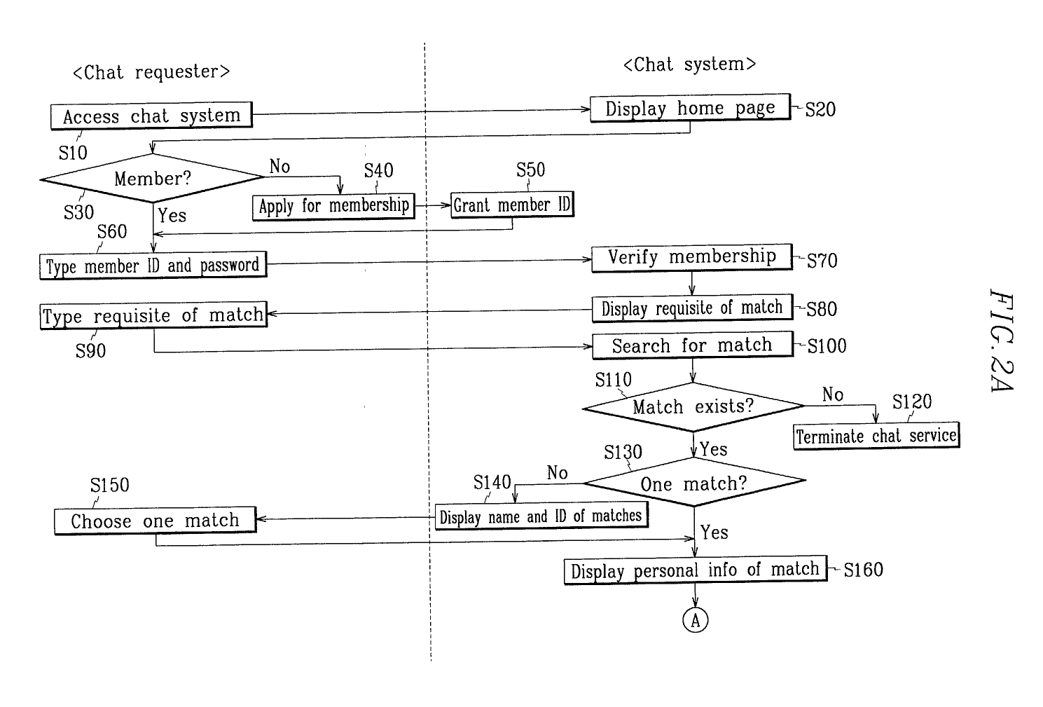

Hereinafter, a description will be given with reference to FIG. 2 as to a method for providing a chat service for mobile terminals in accordance with another embodiment of the present invention.

It is assumed herein that the user of the mobile terminal 10 is the chat-requesting user in the chat system of the present invention.

First, the user of the mobile terminal 10 chooses a chat service menu among the menus displayed on the window of the terminal 10 and attempts to connect the chat server 70. Then, the mobile terminal 10 gets in radio communication with the base station 210 and transfers the corresponding signal to the radio operator server 320. The radio operator server 320 verifies that the received signal is a request message for a chat service, and transfers the corresponding signal to the web server 710 in the chat server 70 over the Internet server 60 connected to the radio operator gateway 50. Thus the radio operator server 320 establishes a communication path between the mobile terminal 10 and the web server 710 and connects the mobile terminal 10 with the web server 710, in step S10. Data transmission between the mobile terminal 10 and the web server 710 is achieved as explained above and will not be described in further detail.

At the request of the user of the mobile terminal 10 (hereinafter, referred to as “chat requester”), the web server 710 of the chat server 70 displays a home page including description on the chat service, in step S20. The home page includes an entry window for member ID and password, and a sign-up window for the chat requester who is not a member of the chat server 70.

If the chat requester is not a member of the chat server 70, in step S30, he/she has to choose the sign-up window to apply for the membership, in step S40. Upon the chat requester's applying for membership, the web server 710 grants a member ID to the chat requester according to specified sign-up procedures, in step S50. The sign-up procedures are performed as follows. The web server 710 urges the chat requester to enter his/her personal and navel information, and stores the entered personal information in the membership database 730 and the navel information in the navel information database 750.

On the other hand, if the chat requester is a member of the chat server 70, in step S30, the web server 710 urges the chat requester to enter the member ID and password, in step S60.

Then, the web server 710 verifies the membership of the chat requester based on the entered member ID and password, in step S70. In the membership verification step (S70), the web server 710 uses the search engine 740 to determine whether the member ID is stored in the membership database 730, and if the member ID is stored in the database 730, determine whether the entered password is identical to the password of the member ID. If the entered password is not the same as the password of the member ID, an error message is displayed to the chat requester; otherwise, it proceeds to the next step.

After the completion of the membership verification step (S70), the web server 710 displays a window urging the chat requester to enter desired requisites for his/her chat partner, in step S80. Then, the chat requester enters desired requisites for his/her chat partner, in step S90. At this time, the chat requester preferably chooses the type of the chat partner, such as “friend”, “lover”, or the like.

Subsequently, the web server 710 uses the search engine 740 to search the membership database 730 for a member meeting the specified requisites for a chat partner of the chat requester, in step S100.

If there is no match for the chat requester, in step S110, the web server 710 displays a message reporting that there is no match and that the chat service will be terminated, in step S120. It is also desirable that the chat requester is allowed to enter another requisites for his/her chat partner and to continue the searching instead of terminating the chat service.

If the searching is successful, the web server 710 determines whether the search engine 740 has found one match or more, in step S130. If there are at least two matches, the web server 710 displays a list of the names and member ID's of the matches to the chat requester, in step S140, and urges the chat requester to select one of the matches, in step S150.

If the search engine 740 has found one match in step S130, or the chat requester selects one of the matches in step S150, the web server 710 extracts the personal information of the selected match from the membership database 730 and displays the extracted personal information to the chat requester, in step S160.

Then, the web server 710 uses the navel information engine 760 to search the navel information database 750 for the navel information of the chat requester and the selected match, and displays navel matching information, e.g., love index to the chat requester, in step S170.

The member-specific navel information includes blood type, favorite diagram, kaivawibo pattern, favorite food, and music genre to listen to with the chat partner.

The navel information engine 760 generates the result of navel matching based on the navel information of the chat requester and the selected match, such as blood type, favorite diagram and the like.

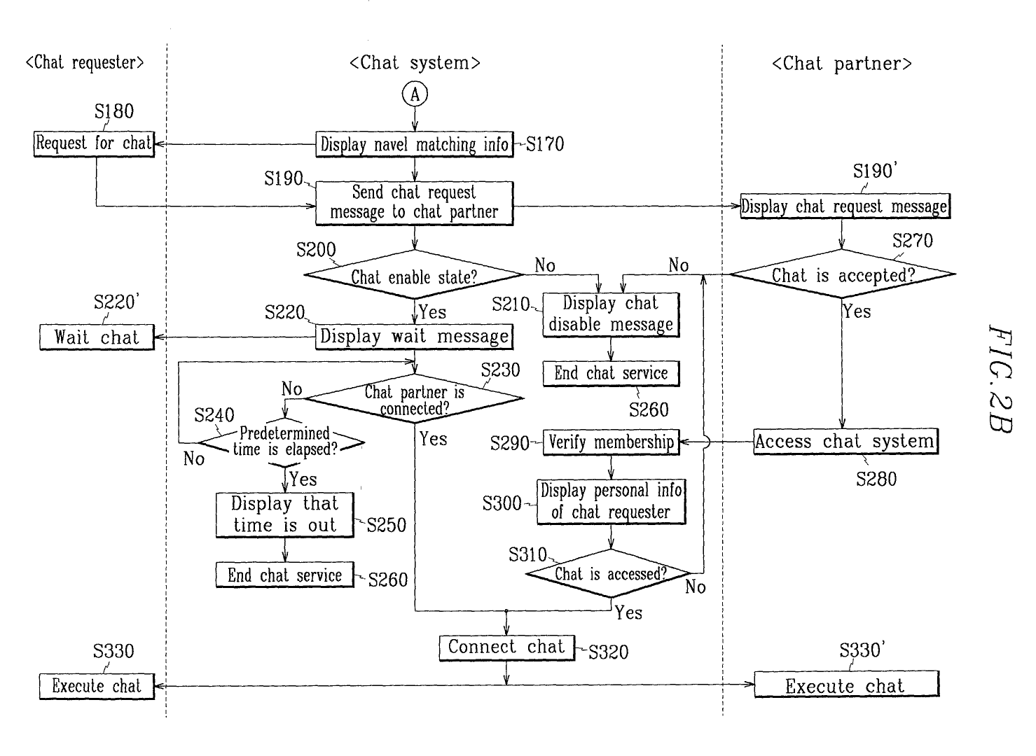

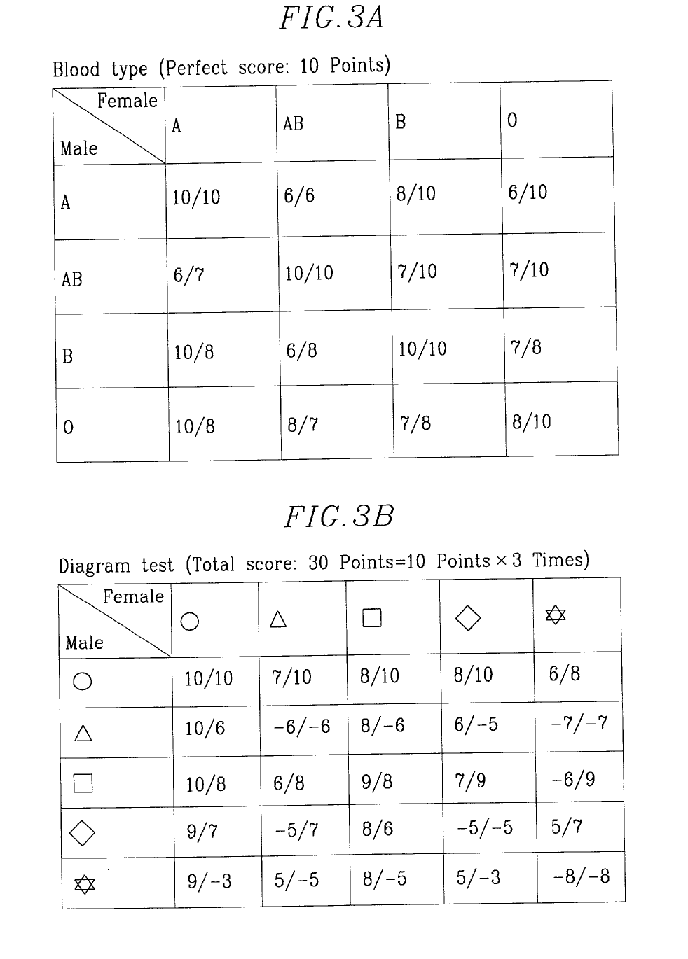

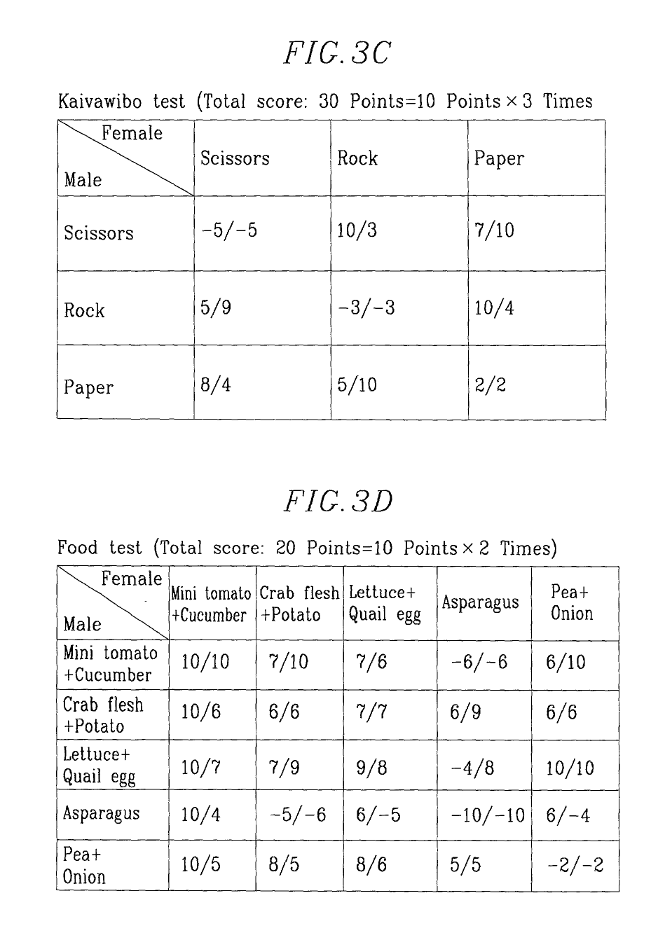

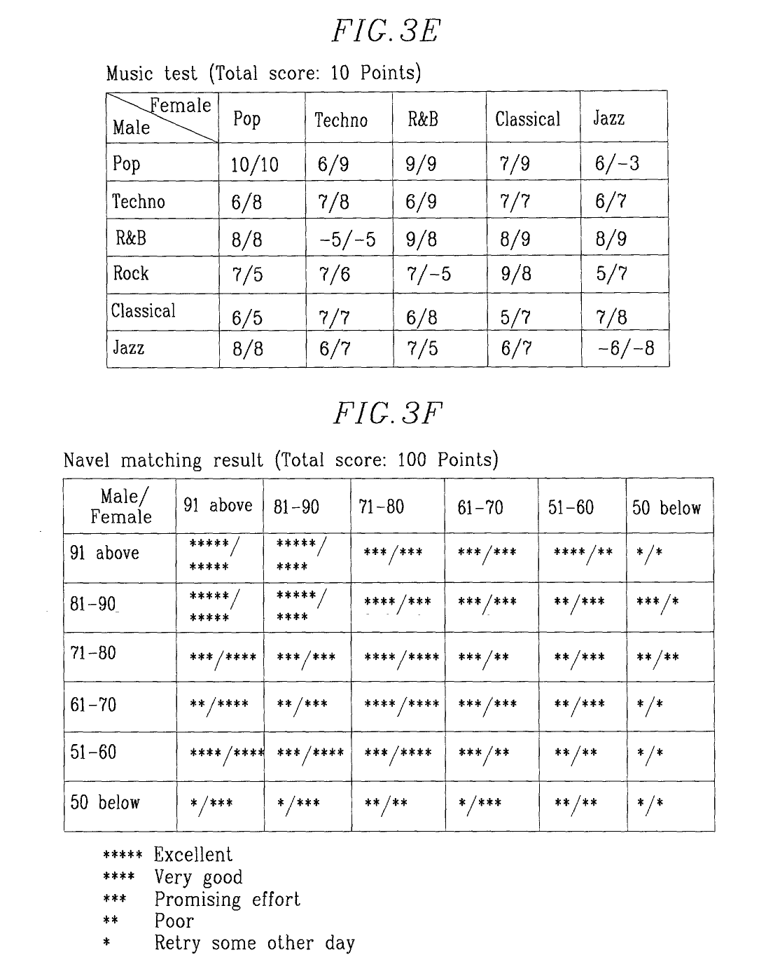

FIGS. 3a to 3e are diagrams showing the examples of navel matching by the navel information, and FIG. 3f shows the results of the navel matching of FIGS. 3a to 3e.

FIG. 3a shows navel matching scores of normal male and female blood types, FIG. 3b nave matching scores of diagram tests, FIG. 3c navel matching scores of kaivawibo patterns in character tests, FIG. 3d navel matching scores of food tests, and FIG. 3e navel matching scores of music tests.

The navel information engine 760 sums up the navel matching scores in the navel matching score tables of FIGS. 3a to 3e based on the navel matching information of the chat requester and the selected match.

The results of the navel matching corresponding to the total scores are acquired from the table of FIG. 3f. It is also desirable to use, as the navel matching information, sentences more effectively indicating the navel matching result such as “excellent”, “very good”, “promising with an effort”, instead of the total scores.

As described above, using the navel matching information between the chat requester and the selected match secures selection of a more ideal chat partner.

Preferably, between the step S160 of displaying the personal information of the selected match and the step S170 of displaying the navel matching information is further included a step of the chat requester's terminating the chat service or searching for another match when the selected match is not in the chat requester's favor.

Subsequently, the chat requester who favors the selected match's personal information and navel information displayed on his/her mobile terminal applies for a chat with the selected match, in step S180. Of course, as described above, the chat requester can terminate the chat service or search for another match when he/she does not care for the displayed information.

Upon the chat request's applying for a chat with the selected match, the web server 710 uses the call engine 770 to call the selected match (hereinafter, referred to as “chat partner”), in step S190. At this time, the web server 710 also sends the chat partner the personal information of the chat requester and the navel matching information between the chat requester and the chat partner in the form of a message.

Although the chat partner can be a user of the mobile terminals 10, 11, 20 and 21 or personal computers directly connected to the Internet server 60, it is assumed in this embodiment that the chat partner is the user of the mobile terminal 20 served by another mobile communication service provider 40.

The call engine 770 connects the mobile communication service provider 40 different from that serving the chat requester via the Internet server 60 and the radio operator gateway 50 connected to the web server 710 and gets in radio communication with the mobile terminal 20 of the chat partner via the base station 410 connected to the radio operator server 420, thereby sending the personal information of the chat requester and the navel matching information in the form of a message to the mobile terminal 20. The message is displayed on the mobile terminal 20 of the chat partner, in step S190′.

If the chat partner is a user of the personal computer directly connected to the Internet server 60, the call engine 770 sends the message to the chat partner by means of an e-mail.

Subsequently, the web server 710 uses the link engine 780 to determine whether the mobile terminal 20 of the chat partner is in the chat enable state, in step S200. Here, the “chat enable state” means that mobile terminal 20 is in an on-line and not-busy state. The link engine 780 ascertains the status of the mobile terminal 20 through the radio operator server 420 being in radio communication with the mobile terminal 20. Preferably, the link engine 780 determines the status of the mobile terminal 20 based on whether the mobile terminal 20 is being in connection with the Internet server 60, in the case where the chat partner is a user of the personal computer directly connected to the Internet server 60.

If the chat partner is not in the chat enable state, the web server 710 displays to the chat requester a message indicating that the chat partner is not in the chat enable state, and allows the chat requester to terminate the chat service or search for another match, in step S210.

If the chat partner is in the chat enable state, the web server 710 displays on the mobile terminal 20 of the chat requester a message indicating that the chat partner is being connected, in step S220, and urges the chat requester to keep waiting, in step S220′.

Then, the link engine 780 determines in step S230 if the chat partner connects the web server 710 of the chat server 70 with his own mobile terminal 20. In the case where the chat partner is a user of the personal computer directly connected to the Internet server 60, the link engine 780 has to determine whether the chat partner connects the web server 710 via the Internet server 60 using his own web browser.

If the chat partner is not in connection to the web server 710 for a predetermined time, in step 240, the link engine 780 displays to the chat requester a message indicating that a wait time for connection has elapsed, in step S250, and terminates the chat service, in step S260.

On the other hand, the chat partner receiving a chat request message in step S180′ determines whether to access the chat service, in step S270.

If the chat partner denies an access to the chat service, the web server 710 sends to the chat request a message indicating that the chat service is unavailable due to the denial of the chat partner, in step S210, and terminates the chat service, in step S120.

If the chat partner accepts an access to the chat service and gets in connection to the web server 710 of the chat server 70, in step S280, the web server 710 verifies the membership of the chat partner based on the member ID and password of the chat partner, in step S290, and displays the personal information of the chat requester to the chat partner, in step S300. In regard to this, the web server 710 may display, in addition to the personal information of the chat requester, the navel matching information between the chat requester and the chat partner in an automatic manner or by request of the chat partner.

The chat partner determines from all information displayed whether to access the chat server, in step S310.

On the other hand, when the chat partner accepts an access to the chat service, the link engine 780 connects the chat requester to the chat partner, in step S320.

Thus the chat requester can have a one-to-one chat service with the chat partner using the mobile terminal 20 connected to his/her own mobile terminal 10, in steps S330 and S330′.

Subsequently, the chat service may be terminated when the chat requester or chat partner disconnects the access to the associated base station 310 or 410.

As described above, as the mobile communication systems 30 and 40 get in connection to the chat server 70 linked to the Internet 60 via the radio operator gateway 50, the user of the mobile terminals can be provided with integrated contents irrespective of the mobile communication service providers. Furthermore, the use of a wide-range radio operator gateway connecting domestic mobile terminals to overseas ones may enable a chat service between users of domestic mobile terminals and ones of overseas mobile terminals in English and other language-speaking countries.

Although the chat service has been described in the case where the chat requester is a mobile terminal user and the chat partner is another mobile terminal user or a personal computer user directly connected to the Internet server 60, it is appreciated that the chat service is also enabled in the case where the chat requester is a personal computer user directly connected to the Internet server 60 and the chat partner is a mobile terminal user.

Although it has been described that the chat service is executed between the chat requester and the chat partner in the one-to-one basis, the chat service is also enabled between one chat requester and multiple chat partners when the chat server 70 has found multiple chat partners or the chat requester wants to have a chat with multiple chat partners.

The requisite information for a chat partner is not limited to the navel information and may include the character information of the chat partner.

It is also desirable in step S120 or S260 that the user is enabled to enter another requisite for a chat partner and continue searching for the chat partner instead of causing an operation to end the chat service or terminating the chat service.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the present invention, the user of the mobile terminal searches for a chat partner meeting some specified requisites so as to access a chat service on a one-to-one basis in real time, thus enhancing the chat success rate, and uses the navel matching information based on the navel information as well as character information to select a chat partner with enhanced reliability to the chat service.

Upon a request of a mobile terminal user for a chat service using a mobile terminal, the chat server 70 calls an adequate chat partner to have an access to the chat service with the chat requester so that a real-time chat service is available.

Furthermore, the chat service is available irrespective of the mobile communication service provider and thus the search range of the chat partner is enlarged to maximize the chat success rate.

What is claimed is:

1. A system for providing a chat service, which enables a user of a mobile terminal to search for another user meeting some specified requisites for a chat partner and to virtually talk with him/her, the system comprising:
a mobile communication system being in radio communication with the mobile terminal;
a chat server connected to a network for providing the chat service; and
a radio operator gateway for switching different data and protocols between the mobile communication system and the network,
wherein the chat server includes personal information and requisite information of at least one member,
wherein upon a request of the user of the mobile terminal for the chat service, the system searches for a member meeting the requisites of the user for a chat partner based on the personal information of the individual members, compares the requisite information of the user with that of the searched member to select a chat partner and enables the user to virtually talk with the selected chat partner.

2. The system as claimed in claim 1, wherein the chat server comprises:
a web server connected to the network for displaying a home page and web pages related to the chat service and control the whole chat service-related operation;
a membership database for storing personal information of the user and the member;
a requisite information database for storing requisite information of the user and the member;
a search engine connected to the web server for searching the membership database for the personal information of the member;
a requisite information engine connected to the web server for searching for the requisite information of the member and comparing the searched requisite information with that of the user;
a call engine connected to the web server for calling a member meeting the specified requisites of the user for a chat partner;
a link engine connected to the web server for connecting the user to the member called as a chat partner by the call engine; and
a chat executing server connected to the call engine and the link engine for causing the user to have a chat with the member connected as a chat partner by the link engine.

3. The system as claimed in claim 1, wherein the mobile communication system comprises at least one mobile communication service system,
wherein the at least one mobile communication service system includes a base station being in radio communication with the individual mobile terminal, and a radio operator server for processing a call received from the mobile terminal via the base station,
wherein the at least one mobile communication service system is connected to the network via the radio operator gateway.

4. The system as claimed in claim 3, wherein the at least one mobile communication service system belongs to at least two mobile communication service providers.

5. The system as claimed in any one of claims 1 to 4, wherein the requisite information is navel information including physical attribute and hobby information of the individual member, wherein the system selects the chat partner based on the result of navel matching relating to comparison of the navel information between the user and the searched member.

6. The system as claimed in claim 5, wherein the navel information includes blood type, favorite diagram, kaivawibo pattern, favorite food, and music genre to listen to with the chat partner.

7. The system as claimed in any one of claims 1 to 4, wherein the requisite information is the character information of the member, wherein the system selects the chat partner based on the comparison of the character information between the user and the searched member.

8. The system as claimed in claim 1, wherein the chat partner is another user of the mobile terminal than the user of the mobile terminal requesting for the chat service.

9. The system as claimed in claim 1, wherein the chat partner is the user of a computer system connected to the network.

10. A method for providing a chat service, which enables a user of a mobile terminal to search for another user meeting some specified requisites for a chat partner and to virtually talk with him/her, the method comprising the steps of:
causing the chat-requesting user to enter requisites for a chat partner;
searching for a member meeting the requisites;
comparing the requisite information of the searched member with that of the user to search for the chat partner;
calling the searched chat partner; and
enabling the chat service between the called chat partner and the chat-requesting user.

11. The method as claimed in claim 10, wherein the requisites include the personal information of the chat partner.

12. The method as claimed in claim 10, wherein the requisite information is the navel information of the member, wherein the chat partner is selected based on navel matching information between the user and the searched member.

13. The method as claimed in claim 10, wherein the requisite information is the character information of the member, wherein the chat partner is selected based on a comparison of the character information between the user and the searched member.

14. The method as claimed in claim 10, wherein in the step of calling the chat partner, the personal information of the user and the navel matching information between the user and the chat partner are displayed to the chat partner.

15. The method as claimed in claim 10, further comprising a step of determining whether the chat partner is in a chat enable state, prior to the step of enabling the chat service between the user and the chat partner.

16. A storage medium for storing a program executing the chat service providing method according to claims 10 to 15.
